(19) United States
(12) Patent Application Publication
(10) Pub. No.: US 2023/0400565 A1
(43) Pub. Date: Dec. 14, 2023

(54) FULL BODY TRACKING USING FUSION DEPTH SENSING

(71) Applicant: MICROSOFT TECHNOLOGY LICENSING, LLC, Redmond, WA (US)

(72) Inventors: Ruben CABALLERO, San Jose, CA (US); Jouya JADIDIAN, Mountain View, CA (US)

(21) Appl. No.: 17/838,139

(22) Filed: Jun. 10, 2022

(51) Int. Cl. G01S 13/72; G01S 13/86; G06F 1/16

(52) U.S. Cl. CPC G01S 13/72; G06F 1/163; G01S 13/86

(57) ABSTRACT

Techniques disclosed herein may be utilized to detect, measure, and/or track the location of objects via radar sensor devices that are affixed to a wearable device. Each of the radar sensors (e.g., MIMIC radar sensor) generates, captures, and evaluates radar signals associated with the wearable device (e.g., HMD) and the surrounding environment. Objects located within the field of view with sufficient reflectivity will result in radar return signals each with a characteristic time of arrival (TOA), angle of arrival (AOA), and frequency shift (Doppler shift). The sensed return signals can be processed to determine distance and direction, as well as identification of the objects based on radar characteristics of the object (e.g., radar back-scatter or cross-section pattern). Object information, including position and identification, may be further resolved based on correlation with measurements from one or more of the digital cameras or inertial measurement units.

### BACKGROUND

Mixed Reality (MR) technologies, which may include both Augmented Reality (AR) and Virtual Reality (VR), is being used in a number of different industries with a rapidly expanding footprint. A MR environment is a virtualized 3D universe that includes audio-visual (AV) elements in both a computer-generated environment and a real-world physical environment. Many different technologies can be leveraged to create robust mixed reality experiences, including AV capture devices, sensory input-output (TO) devices, image display devices, and various configurations of embedded and/or cloud based processors.

A 3D representation of a user can be inserted into a MR environment by one or more devices that may be physically worn by the user. For example, a MR device may be implemented as a near-eye-display (NED) or head mounted display (HMD) that may include left and right image display devices that present 3D perspectives views of the virtualized 3D universe. An MR device may also include speakers, transducer, or other audio devices to further immerse the user with a 3D spatial audio experience. In addition to presenting an AV experience to the user, an MR device may perform additional functions such as: capturing AV images from the real world, performing spatial mappings of real-world objects into the virtualized 3D universe, interpreting human speech or vocal gestures from the user, tracking eye gaze and game controller positions of the user, and the like.

To provide a truly immersive MR experience, accurate motion tracking of the user and objects in the real physical may be desired. For example, user movements may be tracked by capture of video images from one or more digital cameras, capture of inertial measurements from one or more accelerometers or inertial measurement units (IMUs), and correlation processing to map captured images to inertial measurements.

The disclosure made herein is presented with respect to these and other considerations.

### SUMMARY

The techniques disclosed herein may be utilized to detect, measure, and/or track the location of objects via radar sensor devices that are affixed to a wearable device. Each of the radar sensors (e.g., MMIC radar sensors) generates, captures, and evaluates radar signals associated with the wearable device (e.g., HMD) and the surrounding environment. Objects located within the field of view with sufficient reflectivity will result in radar return signals each with a characteristic time of arrival (TOA), angle of arrival (AOA), and frequency shift (Doppler shift). The sensed return signals can be processed to determine distance and direction, as well as identification of the objects based on radar characteristics of the object (e.g., radar back-scatter or cross-section pattern). Object information, including position and identification, may be further resolved based on correlation with measurements from one or more of the digital cameras or inertial measurement units.

In some embodiments, a body worn device that is worn by a user to track world objects in a virtual space is described. The device includes a first RF transceiver system, a second RF transceiver system, a third RF transceiver system, a fourth RF transceiver system and an application processor. The first RF transceiver system is at a first position of the body worn device and configured to capture radar return signals in a first field of view. The second RF transceiver system is at a second position of the body worn device and configured to capture radar return signals in a second field of view. The third RF transceiver system is at a third position of the body worn device and configured to capture radar return signals in a third field of view. The fourth RF transceiver system is at a fourth position of the body worn device and configured to capture radar return signals in a fourth field of view. The application processor is configured to receive the captured radar return signals from the first, second, third and fourth RF transceiver systems, and also configured to: cluster the captured radar return signals into one or more localized objects, evaluate signals from the clusters to identify localized objects as one or more of the real world objects, and update tracking position information associated with each identified real world object in the virtual space.

In some additional embodiments an application processor in a body worn device that is configured to track real world objects in a virtual space is disclosed. The application processor is configured by computer readable instructions to: capture radar sensor data from multiple beams directed in a direction relative to the user; cluster the captured radar sensor data into one or more localized objects; evaluate radar sensor data from the clusters to identify localized objects as one or more of the real world objects; and update tracking position information associated with each identified real world object in the virtual space.

Some embodiments describe methods for an application processor to track real world objects in a virtual space with a body worn device. Example methods include: capturing radar return signals from multiple antenna beams, wherein each of the multiple antenna beams includes a different field of view relative to a position on the body worn device; clustering the captured radar return signals into one or more localized objects based on measurements made in their field of view; evaluating signals from the clusters to identify real world objects based on radar signature characteristics associated with one or more of the real world objects; and updating tracking position information associated with each identified real world object in the virtual space.

Features and technical benefits other than those explicitly described above will be apparent from a reading of the following Detailed Description and a review of the associated drawings. This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “techniques,” for instance, may refer to system(s), method(s), computer-readable instructions, module(s), algorithms, hardware logic, and/or operation(s) as permitted by the context described above and throughout the document.

### BRIEF DESCRIPTION OF THE DRAWINGS

The Detailed Description is described with reference to the accompanying figures. In the figures, the left-most digit(s) of a reference number identifies the figure in which the reference number first appears. The same reference numbers in different figures indicate similar or identical items. References made to individual items of a plurality of items can use a reference number with a letter of a sequence of letters to refer to each individual item. Generic references to the items may use the specific reference number without the sequence of letters.

FIG. 1 is a perspective view of a user that is wearing a head mount display device that includes multiple sensors.

FIG. 2A schematically illustrates a first body worn device that includes multiple sensors.

FIG. 2B schematically illustrates a second body worn device that is configured to coordinate tracking of objects via one or more cloud based services.

FIG. 3A is a perspective view of another head mount display device that includes multiple sensors.

FIG. 3B is a perspective view of another head mount display device that includes multiple sensors.

FIG. 4A is a perspective view of a user with a head mount display device that detects real-world objects.

FIG. 4B is a perspective view of a user with a head mount display device that detects a floor surface.

FIG. 4C is a perspective view of a user with a head mount display device that detects hand locations.

FIG. 5 is a side view of a front portion of a head mount display device and optional locations and angles of sensors.

FIG. 6A illustrates perspective views for forward fields of view associated with a pair of sensors in an example head mounted display device.

FIG. 6B illustrates perspective views for tilted fields of view associated with upper or top sensors in an example head mounted display device.

FIG. 6C illustrates perspective views for tilted fields of view associated with lower or bottom sensors in an example head mounted display device.

FIG. 6D illustrates perspective views associated with overlapped fields of view for upper and lower sensors in example head mounted display devices.

FIG. 6E illustrates another perspective view associated with overlapped fields of view for upper and lower sensors in example head mounted display devices.

FIG. 7 is a flow chart illustrating an example process for identification and tracking of objects with a head mounted display device that includes multiple sensors.

FIG. 8 is a schematic drawing of an example computing system capable of implementing aspects of the techniques and technologies presented herein.

### DETAILED DESCRIPTION

In the following detailed description, reference is made to the accompanied drawings, which form a part hereof, and which is shown by way of illustration, specific example configurations of which the concepts can be practiced. These configurations are described in sufficient detail to enable those skilled in the art to practice the techniques disclosed herein, and it is to be understood that other configurations can be utilized, and other changes may be made, without departing from the spirit or scope of the presented concepts. The following detailed description is, therefore, not to be taken in a limiting sense, and the scope of the presented concepts is defined only by the appended claims.

Throughout the specification and claims, the following terms take the meanings explicitly associated herein, unless the context clearly dictates otherwise. The meaning of “a,” “an,” and “the” includes plural reference, the meaning of “in” includes “in” and “on.” The term “connected” means a direct electrical connection between the items connected, without any intermediate devices. The term “coupled” means a direct electrical connection between the items connected, or an indirect connection through one or more passive or active intermediary devices and/or components. The terms “circuit” and “component” means either a single component or a multiplicity of components, either active and/or passive, that are coupled to provide a desired function. The term “signal” means at least a power, current, voltage, data, electric wave, magnetic wave, electromagnetic wave, or optical signal. Based upon context, the term “coupled” may refer to a wave or field coupling effect, which may relate to a corresponding optical field, magnetic field, electrical field, or a combined electromagnetic field.

Techniques disclosed herein may be utilized to detect, measure, and/or track the location of objects via radar sensor devices that are affixed to a wearable device. An example wearable device may be a MR device such as a wearable HMD or another wearable device such as a glove. As will be described herein, each of the radar sensors (e.g., MMIC radar sensors) are configured to generate, capture, and evaluate radar signals associated with the wearable device and the surrounding environment. Objects that are located within the field of view, which have a sufficient reflective area will result in radar return signals (e.g., backscatter or radar cross-section) with characteristics such as time of arrival (TOA), angle of arrival (AOA), and frequency shift (Doppler shift). The sensed return signals can be processed to determine distance and direction, as well as identification of the objects based on radar characteristics of the object (e.g., radar back-scatter pattern). Object information, including position and identification, may be further resolved based on correlation with measurements from one or more of the digital cameras or inertial measurement units.

In accordance with the present disclosure, various examples may be implemented as devices, systems and/or methods to track objects in a real-world environment with a wearable device. Wearable device solutions are described, with reduced cost of manufacturing and improved accuracy of tracking position of objects relative to the wearable device. Example objects that may be tracked, without requiring any specific body worn controller or reflector, may include both environmental elements (e.g., walls, floor, ceiling, or room objects) and/or specific body parts of the user (e.g., hands, feet, legs, torso, head, shoulder).

In some examples, viable antenna in package implementations are described with radar based devices that may be used to sense depth or distance to real-world objects that are located within the field of view (FOV). Many benefits may be realized by the described techniques. For example, the radar based measurements may be combined with measurements from other devices such as a camera device or an inertial measurement unit (IMU), so that correlation and fusion of depth sensed measurements may be leveraged for improved object tracking. The objects that are tracked may include full body tracking of the user, with or without the use of hand devices such as handheld controllers, wristbands, pucks, or gloves. As will be further described herein, leg, feet, torso, and head positions may all be tracked by careful position and orientation of the radar sensor device such that full body tracking in the 3D virtualized world may be realized. The need for ground (or headset height) detection and calibration may also be eliminated since the radar sensors can be configured to detect ground, walls, and ceilings. Technical benefits other than those specifically described herein might also be realized through implementations of the disclosed technologies.

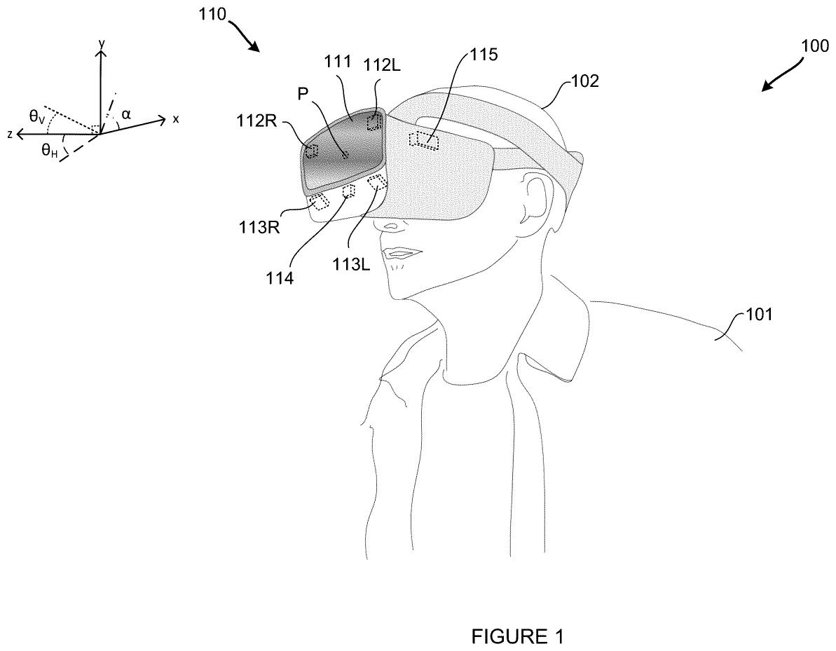

FIG. 1 is a perspective view 100 of a user 101 that is wearing a head mount display device 110 that is configured in accordance with at least some aspects described herein. As shown, user 101 has a head mounted display device (HMD) 110 that is affixed or worn on the user's head 102. The front portion 111 of the HMD, which also corresponds to the outer portion of the display area(s), is positioned in front of the user's eyes of the worn device 110. Various sensor devices and other system components 112R, 112L, 113R, 113L, 114 and 115 are positioned about the HMD as will be described.

The forward facing direction of HMD 110 will be substantially perpendicular to the surface of the front portion 111 of the HMD. For example, when the front portion 111 is in a x-y plane, the forward facing direction of HMD 110 is along a z-axis that is perpendicular to the x-y coordinate plane. Similarly, in this head position, the rear facing direction of HMD 110 is along the z-axis in an opposite direction (e.g., −z). As the head and body position of the user changes, the absolute position or location of the x-y plane and the z-axis may change, but the relative position of the x-y plane and z-axis are maintained in alignment with the front portion 111 of the HMD 110.

As shown, HMD 110 includes a pair of upper sensors 112R, 112L that are positioned about right and left upper corners of the front portion 111 of the HMD 110. A pair of lower sensors 113R, 113L are also shown, which are positioned about right and left lower corners of the front portion 111 of the HMD 110. Although shown in the upper and lower corners of the HMD 110, the specific location of the sensors 112R, 112L, 113R, 113L may be varied away from the corners. Also, the sensors 112R, 112L, 113R, 113L may be either located on a surface of HMD 110 or embedded within a portion of HMD 110.

The sensor devices 112R, 112L, 113R and 113L may correspond to radar sensors that are configured to provide radar measurements associated with the HMD 110 and the surrounding environment. Each of the sensors 112R, 112L, 113R and 113L is located in a different physical position of HMD 110, so that each of the sensors has a different field of view (FOV). The combined fields of view for all of the sensors 112R, 112L, 113R and 113L may be either overlapping or non-overlapping based on these sensors positions.

The precise positions of each of the radar sensors 112 and 113 on the HMD 110 may be varied horizontally (e.g., along an x-axis) and vertically (e.g., along a y-axis). In one example, the specific position of sensor 112R may be horizontally equidistance (e.g., along the x-axis) from the position of sensor 112L relative to a central position P of the front portion 111 of HMD 110. In another example, the specific positions of the lower pair of sensors 113R and 113L may be vertically equidistance (e.g., along the y-axis) from the upper pair of sensors 112R and 112L relative to the central position P of the front portion 111 of HMD 110.

A rotational angle (e.g., α) of each the sensors 112 and 113 relative to the x-axis and y-axis may be varied, as may be desired in certain embodiments. Additionally, an angular tilt position of each of the sensors 112 and 113 may be varied relative to a z-axis so that a direction of the field of view may be varied for the corresponding sensor. For example, a vertical tilt angle θ_{V} may be defined as a direction for a sensor relative to an angle between the z-axis and the y-axis; while a horizontal tilt angle θ_{H} may be defined as a direction for a sensor relative to an angle between the z-axis and the x-axis. In another example, the directional tilt may be defined as a directional vector in a spherical coordinate system that includes radial distance (r), angle of inclination (θ) and azimuth (ϕ).

In some examples, one or more of the sensor devices 112R, 112L, 113R, and 113L may also include or be co-located with one or more inertial measurements units or IMUs that are configured to capture inertial measurements based on a position and orientation of the HMD 110. In still other examples, one or more of the sensor devices 112R, 112L, 113R, and 113L may also include or be co-located with one or more digital camera devices that are configured to capture images of the surrounding environment of the HMD 110.

An additional sensor 114 may be positioned about the front portion 111 of the HMD 110. For example, the additional sensor 114 may be located in a lower portion of the HMD about the bridge of the nose as shown in FIG. 1. Although shown in the lower portion of the HMD below the front display, the position of sensor 114 may be varied to either a lower portion of the HMD below the display, an upper portion of the HMD above the display, or a position in the display area as may be desired. Also, multiple additional sensor devices 114 may be employed in other varying locations of the HMD other than as shown. Possible locations for sensor(s) 114 may include a forehead position, an eyebrow position, a nose bridge position, a nose tip position, a nose base or upper lip position, a right temple position or a left temple position. In some other embodiments, additional sensors 114 may be positioned each temple position of the HMD. I

The additional sensor(s) 114 may correspond to another radar sensor, an inertial measurement unit (IMU), a digital camera, or an illumination device. In one example, additional sensor 114 is a camera device that is located above the user's lip below a central position P of HMD 110. In another example, additional sensor 114 corresponds to a pair of camera devices, wherein each of the camera devices is positioned at a different temple position of HMD 110. In still other embodiments, one or more camera devices may be positioned at differing locations than shown in the figures.

HMD 110 may include additional devices and/or system components, which may be located on a side or interior portion of the HMD 110 as shown by component 115 on the left hand side of the unit. Component 115 may correspond to an application processor, another sensor such as an IMU, a communication module, or another system component.

The head-mounted display (HMD) illustrated in FIG. 1, is also configured to rendered images that are presented to a user's eye or eyes via one or more display panels. The example HMD 110 illustrates a single display panel that is viewable with both left and right eyes. However, other examples may include separate right eye and left eye display panels. Therefore, it can be appreciated that the techniques described herein might be deployed within a single-eye device (e.g., a GOOGLE GLASS MR device) or with a dual-eye device (e.g., a MICROSOFT HOLOLENS MR device).

The display panels on some MR devices are transparent so that light received from the surrounding real-world environment passes through the display panel so that objects in the real-world environment are visible to the user's eye(s). Additional computer generated images or other graphical content may also be presented on the display panel to visually augment or otherwise modify the real-world environment viewed by the user through the see-through display panels. In this configuration, the user may view virtual objects that do not exist within the real-world environment at the same time that the user views physical objects within the real-world environment. Thus, an illusion or appearance of the merged or combined the virtual objects are physical objects or physically present light-based effects located within the real-world environment. The display panel on some other MR devices are opaque so that light received from the surrounding real-world environment is blocked and no visible to the user's eye(s). For such devices, camera devices (e.g., digital cameras) may be used to capture the real-world environment and both real-world and computer generated images or other graphical content may be presented together on the display panel.

Further aspects of MR devices, and the body worn devices disclosed herein will become more apparent in the discussions that follow.

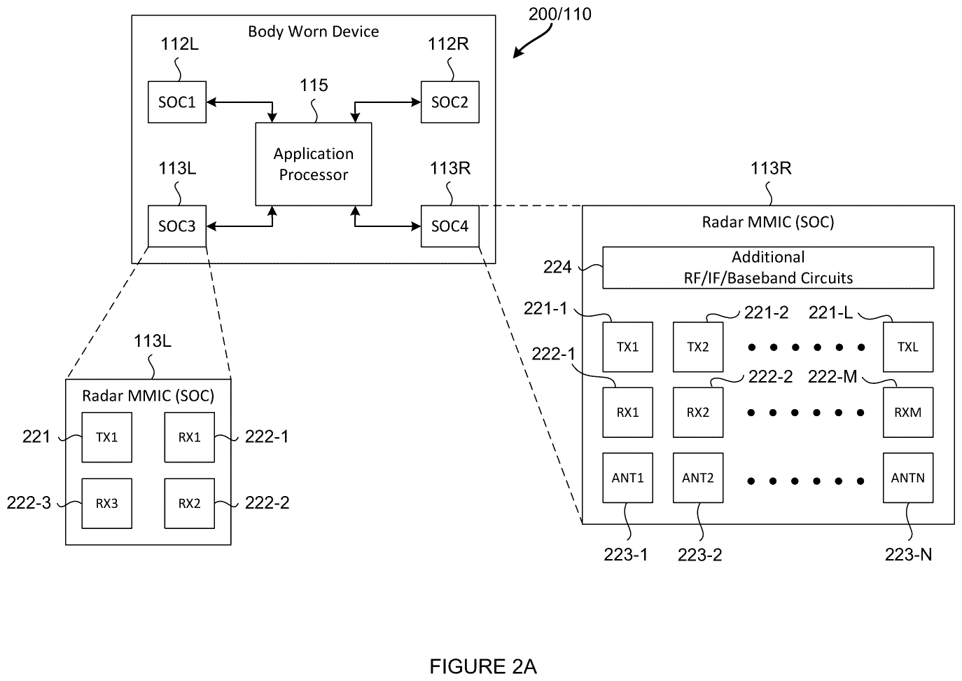

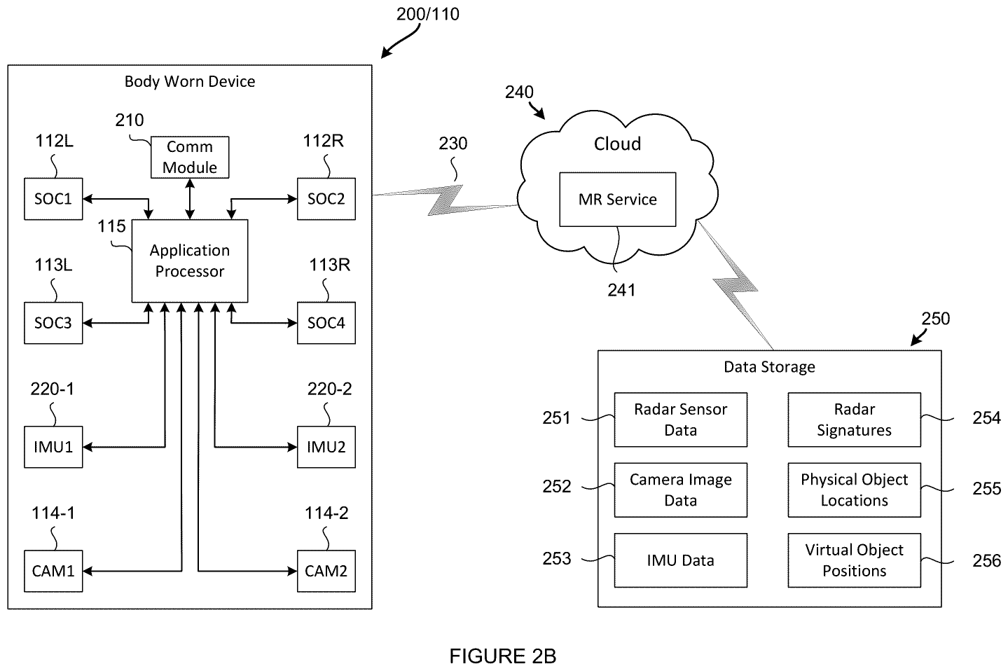

FIG. 2A schematically illustrates a first body worn device 200 that includes multiple sensors arranged in accordance with aspects of the present invention. For example, the body worn device 200 may correspond to HMD 110 with sensors 112R, 112L, 113R and 113L as illustrated in FIG. 1. The body worn device 200 (or 110) may also include an application processor 115.

Each of the sensors 112, 113 may be located at different physical positions such as the locations previously described in FIG. 1 with respect to sensors 112R, 112L, 113R, 113L, etc. The application processor 115 may be comprised of various system components that may be required to control or sequence the operation of the various sensors, collect data, and provide other object tracking and/or image rendering functions as may be required.

In some examples, the body worn device 200 includes four sensors 112L, 112R, 113L and 113R that each correspond to a system on a chip (SOC), which are also illustrated as SOC1, SOC2, SOC3, and SOC4. Although four sensors are illustrated, any number of sensors may be employed depending on the desired implementation and perspectives sensed within different fields of view. Each of the individual sensors may correspond to a radar system on a chip (SOC), which each may be implemented as a monolithic microwave integrated circuit or MMIC. Such MMIC devices are capable of capturing radar measurements, and communicating radar measurement data to the application processor 115.

In one example, sensor 113L is illustrated by a first MMIC implementation of a SOC that includes one transmitter (TX1) 221, and three receivers (RX1, RX2 and RX3) 221-1, 221-2 and 221-3. Although this implementation illustrates one transmitter and three receivers, this is for conceptual simplicity and it is expected that additional components may be included in the MMIC, including but not limited to antenna(s) and other required components for baseband, IF, and RF signal processing. As previously described, the sensor 113L may correspond to a complete radar system on a chip that is capable of communicating radar measurement data to the application processor 115.

A second example sensor 113R is illustrated as a second MMIC implementation of a SOC that includes multiple (L) transmitters 221 (TX1-TXL), multiple (M) receivers 222 (RX1-RXM), multiple (N) 223 antennas (ANT1-ANTN), and additional circuits 224 for RF, IF and baseband processing 224. A larger number of antennas can be utilized to increase the overall size of the field of view for the sensor 113R.

The specific detailed components of the additional circuits may include a variety of RF/IF and baseband circuits such as oscillators and phase locked loops for frequency selection (e.g., 20 GHz-60 GHz), a state machine and/or sequencer to control switching between different RX and TX signal paths with selected antennas, power amplifiers for transmission of radar signals via antennas, low noise amplifiers to capture radar return signals from antennas, I/Q up and down-conversion mixers and filters, pulse and continuous wave control for radar transmission, as well as analog-to-digital conversion for data output. Such radar MIMIC devices that are becoming more readily available include millimeter wave (mmWave) radar devices manufactured by Infineon Technologies (e.g., BGT24LTR11, BGT24LTR22 BGT6OTR13C and BGT6OLTR11A11AIP). Each of these devices includes complete functionality as SOCs that generate, capture, and evaluate radar signals located within a field of view of the corresponding antennas.

FIG. 2B schematically illustrates a second body worn device 200 (or 110) that is configured to coordinate tracking of objects via one or more cloud based services. The body worn device 200 of FIG. 2B include the same basic components as FIG. 2A, with the addition of a communication module 210, two inertial measurement units 220, and two camera devices 114.

Each of the described radar sensors 112L, 112R, 113L and 113R is again illustrated as a system on a chip (SOC1 through SOC4), or an RF transceiver system, which each generate, capture, and evaluate radar signals associated with the wearable device (e.g., HMD) and the surrounding environment. Objects located within the field of view with sufficient reflectivity will result in radar return signals and the corresponding measurements such as distance, time of arrival (TOA), angle of arrival (AOA), frequency shift (Doppler shift), etc. These radar sensor measurements can then be processed either alone by operation of the application processor 115 or by combined operation of the application processor 115 and a cloud based 240 service 241 that may determine distance and direction, as well as identification of the objects based on radar characteristics of the object (e.g., radar back-scatter pattern).

An example MR service 241 is illustrated in FIG. 2A as part of a cloud based service 240. As illustrated, captured radar sensor data may be communicated by the application processor 115 to a cloud based service 240, where a communication link 230 between the application processor 115 and the MR service 241 may be managed by the communication module 210. Data storage and data access that may be required can be facilitated by a mixed reality system may be coordinated between the cloud based MR service 241 and a data storage device 250, which may be cloud based. For example, radar sensor data 251 from application processor 210 may be stored in a data storage 270, and further processed to correlate the backscatter pattern to one of the radar signatures 274 that may be known for identification purposes.

The digital camera devices 114-1 and 114-2 (or CAM1 and CAM2) can be configured to capture camera images relative to their physical position and orientation of the digital cameras on the body worn device 200. Data storage 250 of captured camera images may be facilitated by the cloud based 240 service 241, which corresponds to the Camera Image Data 252 depicted in FIG. 2B.

The inertial measurement units 220-1 and 220-2 (or IMU1 and IMU2) can be configured to capture inertial measurements relative to their physical positions and orientation of the IMUs with respect to the body worn device 200. Data storage 250 of IMU measurements may be facilitated by the cloud based 240 service 241, which corresponds to the IMU Data 253 depicted in FIG. 2B.

Object information that may be required in a particular MR implementation may correspond to identification of objects. When a radar transmitter is active, transmitted waves propagate from the transmitter to the object(s) and reflect off the object(s) in differing amounts based on various reflectivity characteristics. The radar receiver receives and processes these reflected waves to determine characteristics such as time of arrival, angle of arrival, Doppler shift, distance, etc. These measurements, or radar sensor data, give a complete picture of the reflectivity characteristics of the object and thus the application processor or the MR service 241 (or combinations thereof) may match these measured reflectivity characteristics from the radar sensor data 251 to one of the radar signatures 254. Radar sensor measurements from objects are impacted by the type of material found in the object; the size of the reflective target area of the object relative to the wavelength of the illuminating radar signal; the angle of incidence and reflection of the propagated waves; and polarization characteristics of the transmitted and reflected radiation with respect to the orientation of the target. For ground based reflection, a related quantity called backscatter coefficient may be identified in the radar sensor data.

Object positions can also be determined, at least in part, based on distance and other measurements from the radar sensor data. If an accurate position of the user of the wearable device 110 is known, then a relative position of the object can be accurately determined based on the captured radar sensor data (e.g., distance, angle of arrival, time of flight, Doppler, etc.). For example, one or more IMU devices can be configured to capture inertial measurements to determine a precise orientation of the HMD 110; which can then be used to resolve a precise location of a physical object within the field of view of the radar SOCs 112 and 113. Similarly, camera image data may be combined with radar sensor data to tightly correlate the captured images to their locations in the physical world. From these measurements of position and object identity, the physical objects may be mapped into a 3D virtual space to create a merged AR environment.

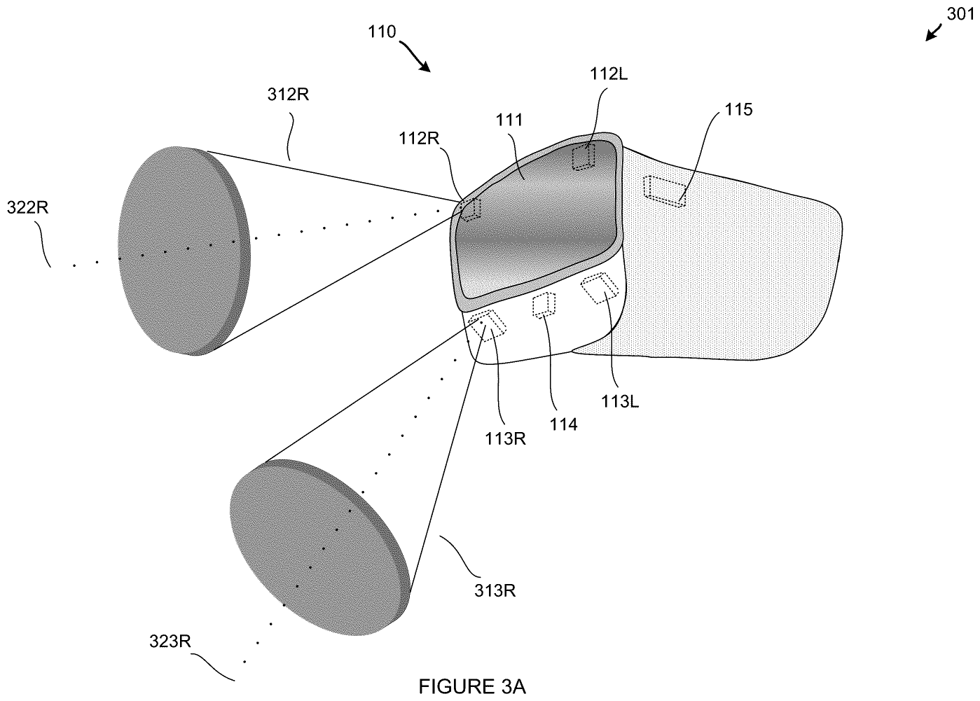

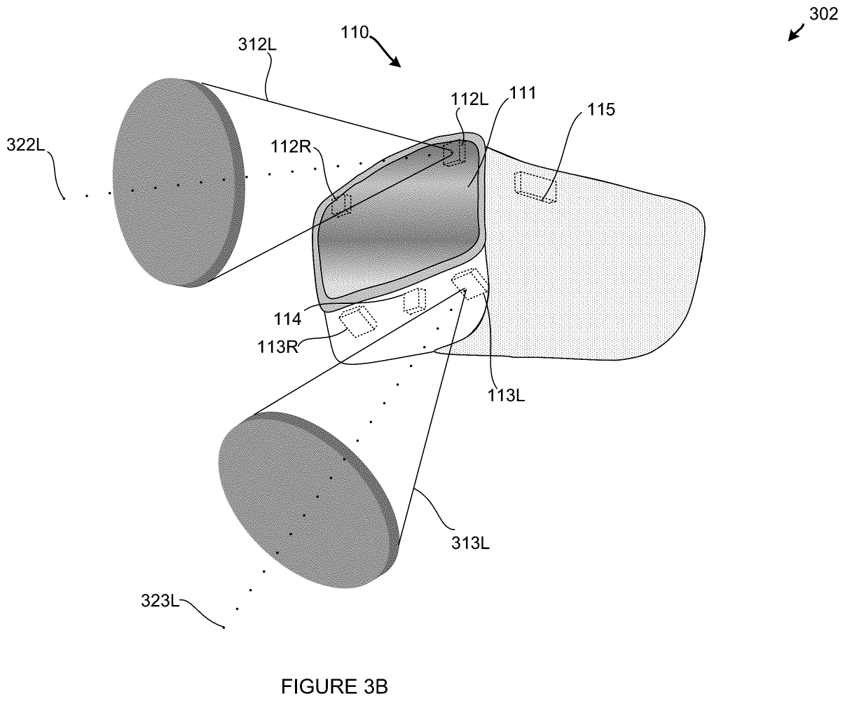

FIG. 3A is a perspective view 301 of another head mount display device 110, which includes multiple sensors. As illustrated, the front portion 111 of the HMD, which also corresponds to the outer display area, includes sensor devices and other system components 112R, 112L, 113R, 113L, 114 and 115 positioned about the HMD 110, similar to FIG. 1.

In FIG. 3A, additional features are graphically illustrated such as the field of view associated with the right side of the device 110. As shown, an upper right located sensor device 112R is aligned to present a field of view 312R that projects along a substantially forward looking axis 322R (or upper line of sight) from the surface 111 of the HMD 110. A lower right located sensor device 113R is tilted slightly downward as shown by field of view 313R, which projects in a direction forward and tilting downward along an axis 323R (or lower line of sight) relative to the surface 111 of the HMD 110. Both the upper right and lower right sensors 112R and 113R may have different tilt angles with different directional axis 322R and 323R for their fields of view 312R and 313R such as described previously with respect to FIG. 1.

FIG. 3B is a perspective view 302 of head mount display device 110 from FIG. 3A, which includes multiple sensors. As illustrated, the front portion 111 of the HMD 110, which also corresponds to the outer display area, includes sensor devices and other system components 112R, 112L, 113R, 113L, 114 and 115 positioned about the HMD 110, similar to FIG. 1.

In FIG. 3B, additional features are graphically illustrated such as the field of view associated with the left side of the device 110. As shown, an upper left located sensor device 112L is aligned to present a field of view 312L that projects along a substantially forward looking axis (or upper line of sight) 322L from the surface 111 of the HMD 110. A lower left located sensor device 113L is tilted slightly downward as shown by field of view 313L, which projects in a direction forward and tilting downward along an axis 323L (or lower line of sight) relative to the surface 111 of the HMD 110. Both the upper left and lower left sensors 112L and 113L may have different tilt angles with different directional axis 322L and 323L for their fields of view 312L and 313L such as described previously with respect to FIG. 1.

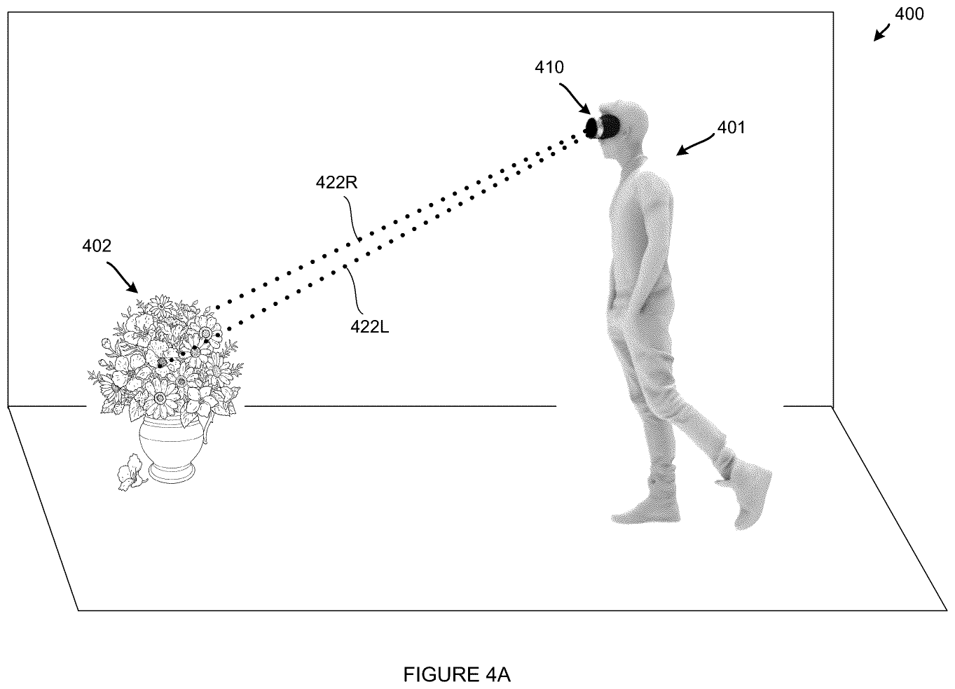

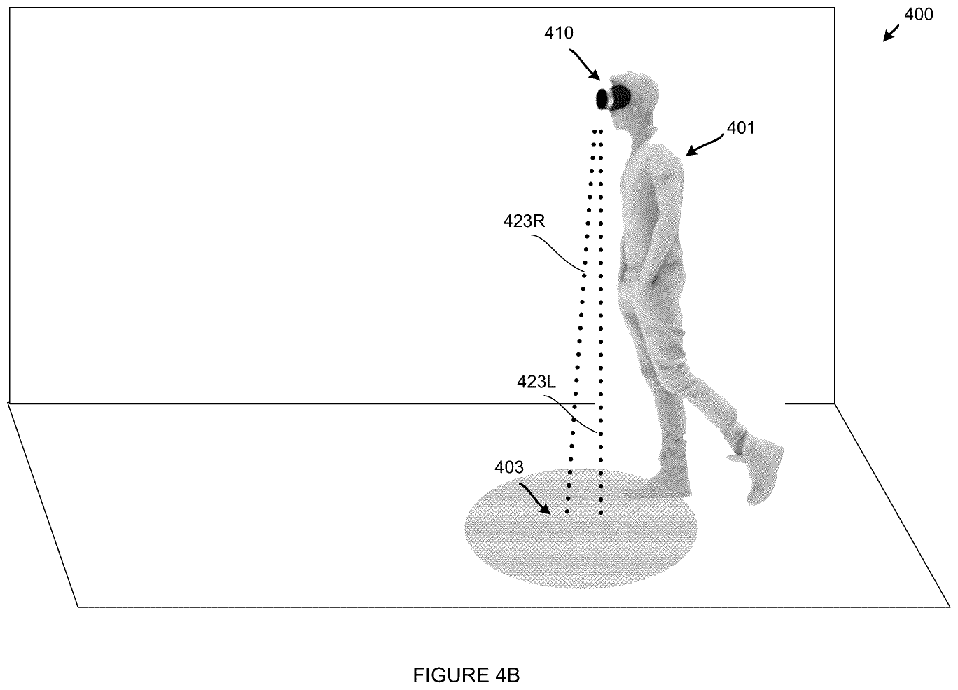

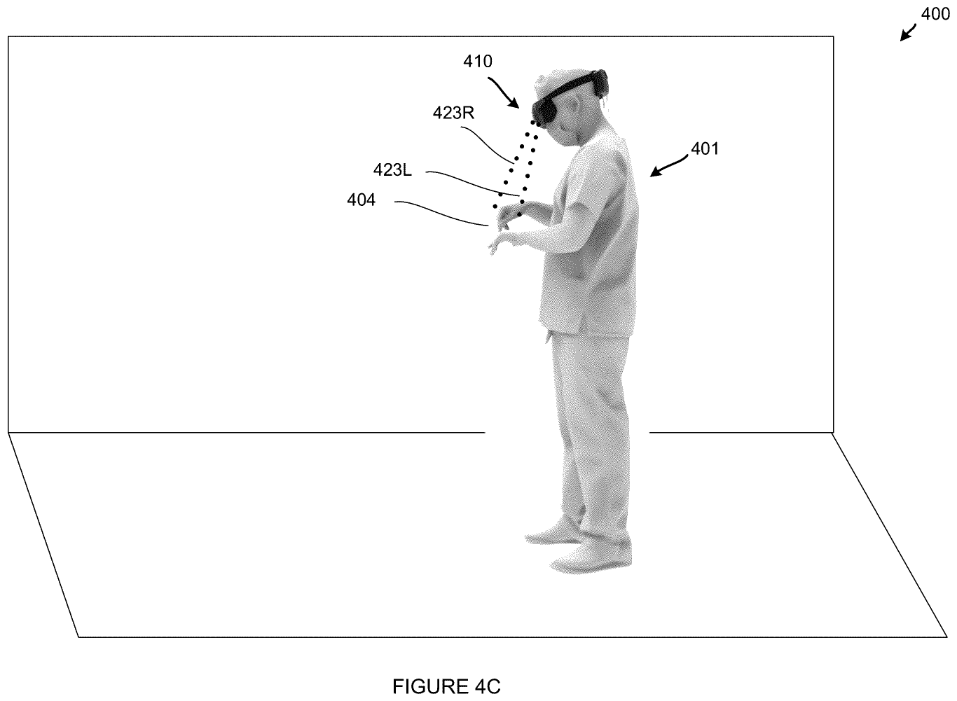

FIG. 4A is a perspective view 400 of a user 401 with a head mount display device 410 that detects real-world objects 402. As shown, as the user 401 is glancing towards the real-world object 402, the upper sensors in the HMD are aligned along a first line of sight a 422R on the right side, and along a second line of sight 422L on the left side. Thus, two radar beams are projected along these alignment axes, resulting in a multibeam radar return signal measurement of the object 402 relative to the HMD 410.

The radar return signals are captured and the application processor may cluster the right and left radar return signals together based on various characteristic measurements such as time of flight, time of arrival, angle or arrival, Doppler shift, signal strength, signal phase, estimated direction or estimated position. The distance and position of the object 402 relative to the user 401 can be accurately determined from the radar return signals. Additionally, the object type can be identified by the application processor via a correlation between the radar cross-section or backscatter pattern as a known radar signature for the specific object. The precise position of the object 402 can be accurately determined once the user's precise location at the time is known, which can be determined by measurements from other devices such as inertial measurements from IMUS and/or camera images from digital cameras.

FIG. 4B is another perspective view 400 of a user 401 with a head mount display device 410 that detects a floor 403. As shown, when the user 401 is glancing about the area, the lower sensors in the HMD are aligned along a first line of sight 423R on the right side, and along a second line of sight 423L on the left side. Thus, two radar beams are projected along these alignment axes, resulting in a multibeam radar return signal measurement of the ground area 403 relative to the HMD 410. Since the ground area has a large radar target area, the radar return signal is strong, meaning the backscatter is high since a significant portion of the incident radar signal reflects directly back towards the transmitting antenna.

The radar return signals are again captured and the application processor, which clusters the right and left radar return signals together based on various features such as time of flight, time of arrival, angle or arrival, Doppler shift, signal strength, signal phase, estimated direction or estimated position. The distance and position of the floor 403 relative to the user 401 can be accurately determined from the radar return signals. Thus, height of the user 401 can also be quickly and accurately determined without any additional calibration.

FIG. 4C is a perspective view 400 of a user 401 with a head mount display device 410 that detects locations of the user's hands 404. As shown, as the user 401 is glancing about in the AR world, the lower sensors in the HMD are aligned along a first line of sight a 423R on the right side, and along a second line of sight 423L on the left side. Thus, two radar beams are projected along these alignment axes, resulting in a multibeam radar return signal measurement of the user's hands 404 relative to the HMD 410.

The radar return signals are captured and the application processor, which clusters the right and left radar return signals together based on various features such as time of flight, time of arrival, angle or arrival, Doppler shift, signal strength, signal phase, estimated direction or estimated position. The distance and position of the hands 404 relative to the user 401 can be accurately determined from the radar return signals. Additionally, the object type can be identified as a human hand by the application processor via a correlation between the radar backscatter pattern and a known radar signature for a specific object type being a human hand. The precise position of the user's hand 404 can be accurately determined once the user's precise location at the time is known, which can be quickly determined by correlated measurements from other devices such as IMUS and/or digital cameras.

In some examples, the object type may correspond to a gameplay object that is a passive device. Some example gameplay objects may be toy shaped such as a steering wheel, a wand, a stylus, a writing implement, a sword, a gun, an axe, a ball, a disc, or some other shaped device that may be useful in an AR based game. For some examples, the gameplay object may be completely passive (e.g., with no active electronics or batteries). Other example gameplay objects may also include a passive radar reflector. By employing the techniques described herein, the position and orientation of the gameplay object may be determined at least partially from radar sensor data. The sensor data may be further correlated with captured camera images and or IMU data from the HMD 110. In some examples, an active device may optionally be added to the gameplay object to facilitate some types of controller inputs such as trigger or button actuation, but no IMU is required in the gameplay device to determine the position of the controller since the system may determine this position from data collected with sensors of the HMD.

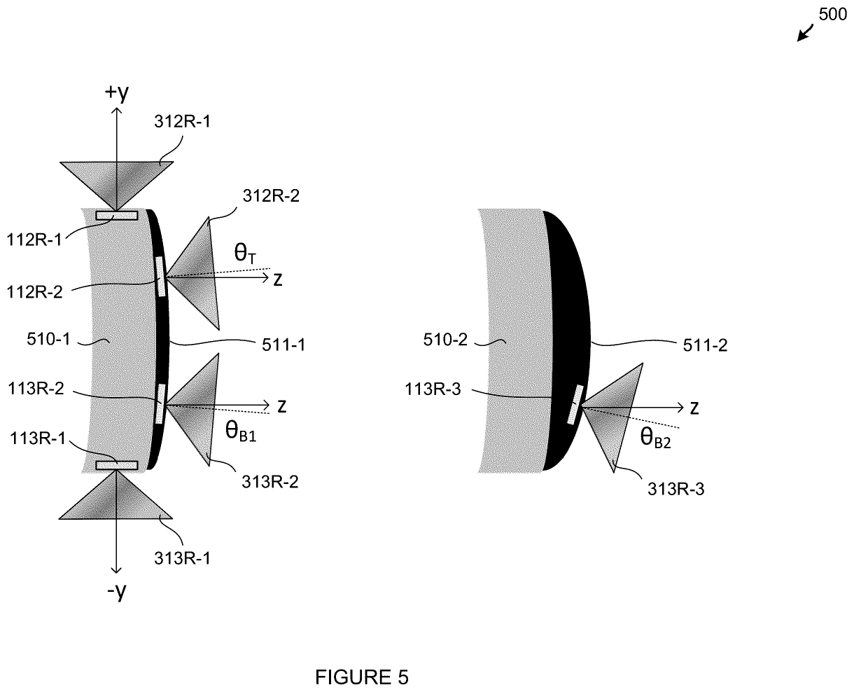

FIG. 5 is a side perspective view 500 of a front portion of a head mount display device and optional locations and angles of sensors. Two different display device types are shown 510-1 and 510-2.

The first display device 510-1 includes four example sensor positions on a right side of the device 112R-1, 112R-2, 113R-1 and 113R-2. The first example sensor 112R-1 is located about an upper or top region of the HMD 510-1, where the field of view 312R-1 is pointing substantially upwards along a y-axis. The second example sensor 112R-2 is located about an upper or top portion of the forward facing surface 511-1 of the HMD 510-1 so that the field of view 312R-2 is pointing forward along a z-axis at an angle θ_{T} that is tilted upwards with respect to the z-axis. The third example sensor 113R-1 is located about a lower or bottom region of the HMD 510-1, where the field of view 313R-1 is pointing substantially downwards along the y-axis. The fourth example sensor 112R-2 is located about a lower or bottom portion of the forward facing surface 511-1 of the HMD 510-1 so that the field of view 313R-2 is pointing forward along a z-axis at an angle θ_{B1}. That is titled downwards with respect to the z-axis.

The second display device 510-2 includes an example sensor 113R-3 that is positioned on a right side of the device. The display design is depicted with a significant curvature on the forward facing surface 511-2. Sensor 113R-3 is located about a lower or bottom region of the HMD 510-2, where the field of view 313R-3 is pointing substantially forward along a z-axis and downward at an angle with respect to the z-axis of θ_{B1}. As shown, the tiled angle may be positioned to match the curvature of the forward facing surface.

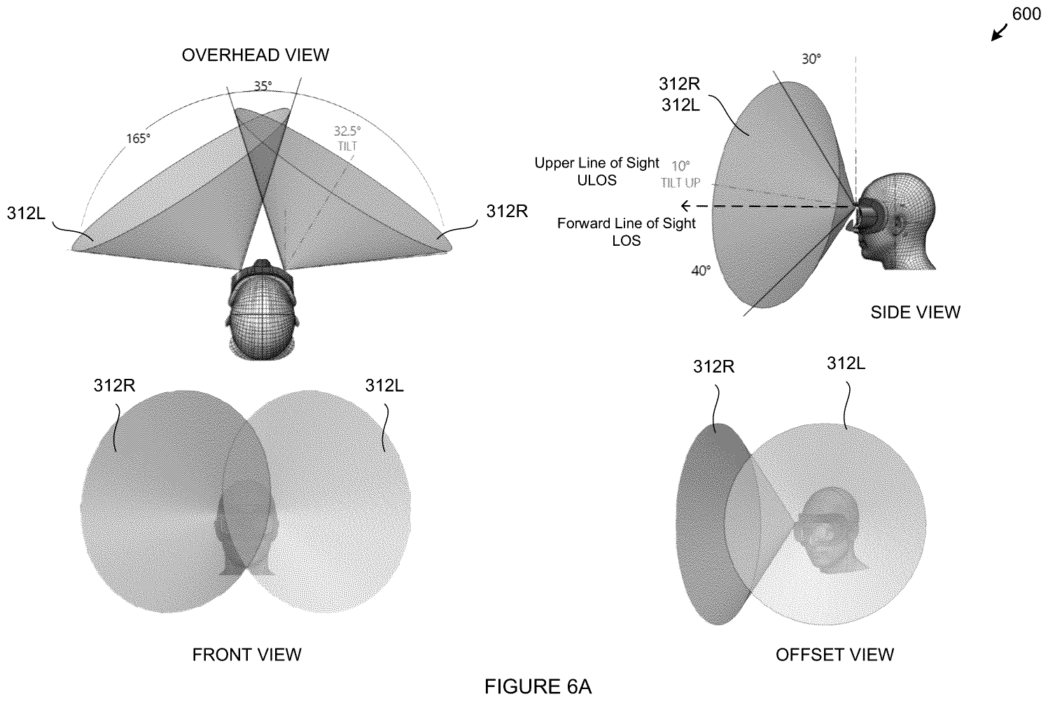

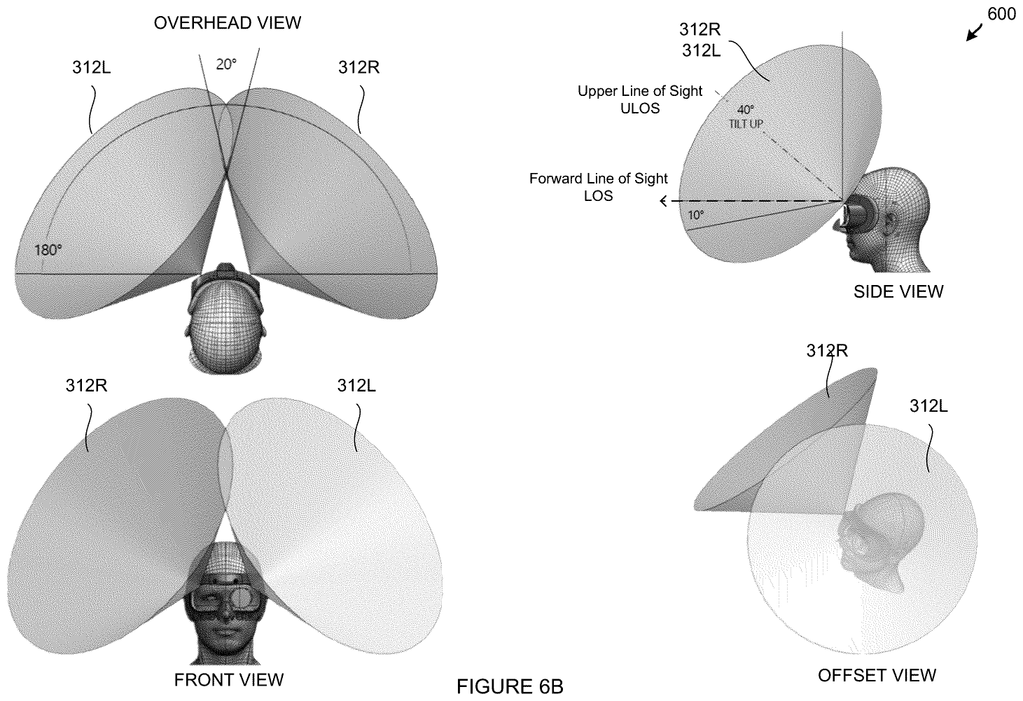

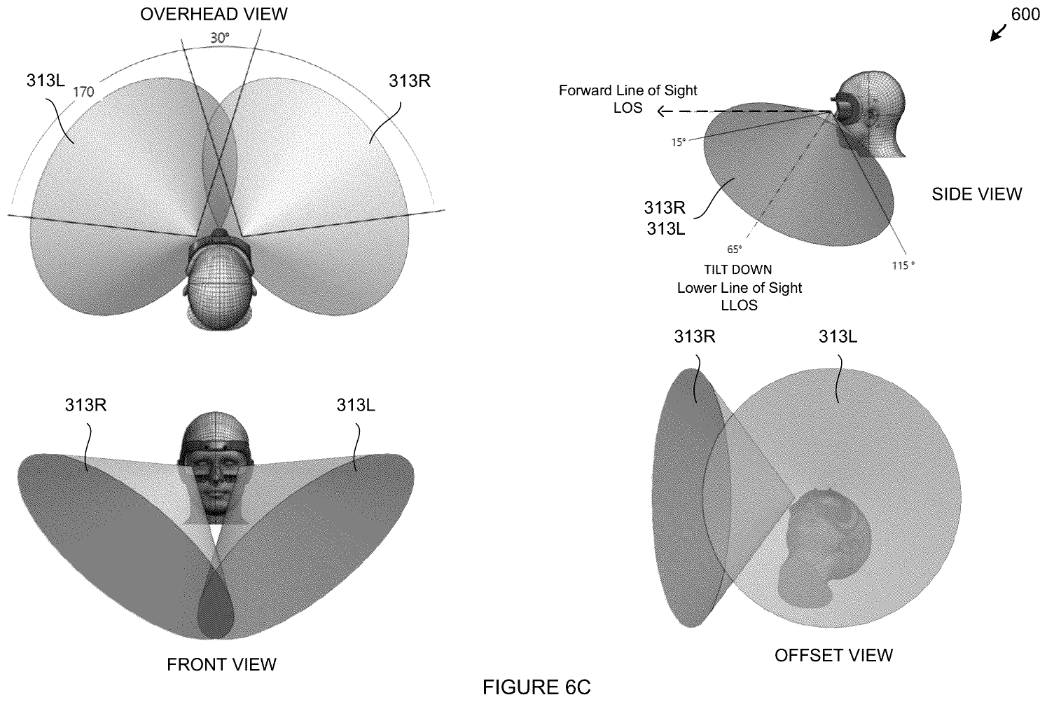

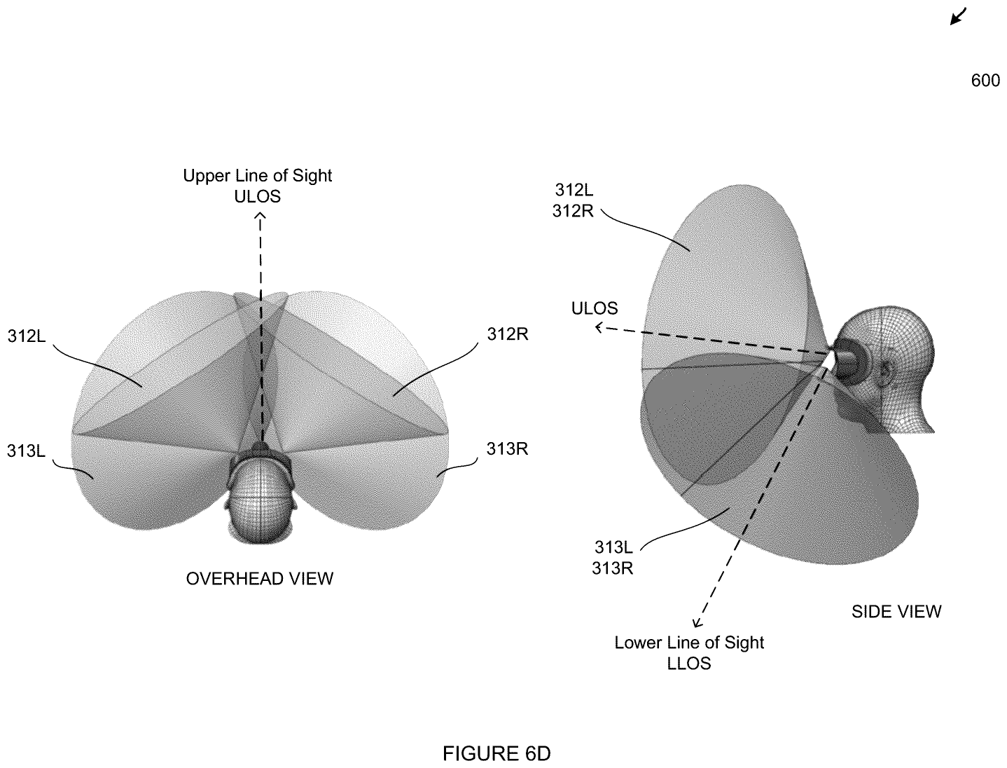

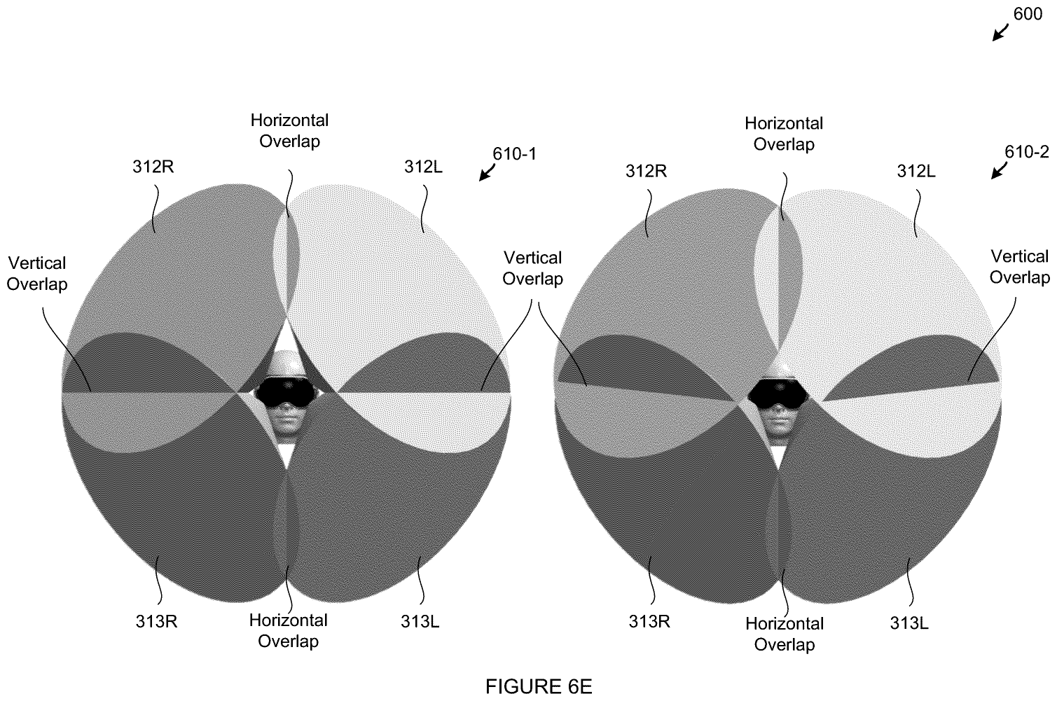

FIG. 6A illustrates perspective views 600 for forward facing fields of view associated with a pair of sensors in an example head mounted display device. In this example, the pair of sensors are located equidistant on right and left sides of the HMD device, in the upper portion of the device relative to the user's forward gaze direction. From the overhead and front views, it can be seen that the left field of view 312L and the right field of view 312R overlap in a central region with about 35 degrees of overlap. The combined fields of view are about 165 degrees wide from the overhead view, where each sensor is positioned to be tilted off axis from the center by about 32.5 degrees to the right or left. From the front and offset views, the fields of view are observed to be centrally located in front of the user's head with substantially round or cone shaped capture areas within the field of view. From the side view, the fields of view are observed to be tilted upwards relative to the user's forward gaze direction by an angle of about 10 degrees. The upward capture area thus corresponds to an angle of about 40 degrees below forward line of sight to an angle of about 30 degrees above the forward line of sight.

FIG. 6B illustrates perspective views for tilted fields of view associated with upper or top sensors in an example head mounted display device. As shown, the pair of sensors are located equidistant on right and left sides of the HMD device, in the upper portion of the device relative to the user's forward gaze direction. From the overhead and front views, it can be seen that the left field of view 312L and the right field of view 312R overlap in a central region with about 20 degrees of overlap. The combined fields of view have a capture area that is about 180 degrees wide from the overhead view. From the front and offset views, the fields of view are observed to be centrally located in front of the user's head and tilted upwards, with substantially round or cone shaped capture areas within the fields of view. From the side view, the fields of view are observed to be tilted upwards relative to the user's forward gaze direction by an angle of about 40 degrees. The upward capture area thus corresponds to an angle of about 10 degrees below forward line of sight to about 90 degrees above the forward line of sight.

FIG. 6C illustrates perspective views for tilted fields of view associated with lower or bottom sensors in an example head mounted display device. As shown, the pair of sensors are located equidistant on right and left sides of the HMD device, in the lower or bottom portion of the device relative to the user's forward gaze direction. From the overhead and front views, it can be seen that the left field of view 313L and the right field of view 313R overlap in a central region with about 30 degrees of overlap. The combined fields of view have a capture area that is about 170 degrees wide from the overhead view. From the front view and the offset view, the fields of view are observed to be centrally located in front of the user's head and tilted downwards, with substantially round or cone shaped capture areas within the fields of view. From the side view, the fields of view are observed to be tilted downwards relative to the user's forward gaze direction by an angle of about 65 degrees. The downward capture area thus corresponds to an angle of about 15 degrees below forward line of sight to about 115 degrees below the forward line of sight.

FIG. 6D illustrates perspective views associated with overlapped fields of view for upper and lower sensors in example head mounted display devices. As shown in an overhead view, the upper fields of view 312L and 312R are substantially forward in an upper line of sight (ULOS) of the user, while the lower fields of view 313L and 313R are angled downward in a lower line of sight (LLOS) of the user. Thus, the upper fields of view are positioned to capture objects in the user's upper line of sight (ULOS), while the lower fields of view 313L and 313R are positioned to capture objects in the user's line of sight. The side view exemplifies the position of the fields of view, where the upper fields of view 312L, 312R are aligned in a direction for an upper line of sight (ULOS), and the lower fields of view 313L and 313R are aligned in a direction for a lower line of sight (LLOS). The side view also exemplifies an overlap between the upper fields of view and the lower fields of view by about 25 degrees.

FIG. 6E illustrates another perspective view 600 associated with overlapped fields of view for upper and lower sensors in example head mounted display devices. In first example HMD 610-1, the right fields of view 312R and 313R and the left fields of view 312L and 313L have a horizontal overlap from right to left of about 20 degrees, while the upper fields of view 312R and 312L and the lower fields of view 313R and 131L have a vertical overlap from top to bottom of about 25 degrees. In second example HMD 610-1, the right fields of view 312R and 313R and the left fields of view 312L and 313L have a horizontal overlap from right to left of about 35 degrees, while the upper fields of view 312R and 312L and the lower fields of view 313R and 131L have a vertical overlap from top to bottom of about 25 degrees.

The above described values and ranges for fields of view, tilt angles, horizontal overlaps, and vertical overlaps illustrated in FIGS. 6A-6E are merely examples, and other values and ranges thereof are contemplated.

In some examples, each sensor has a field of view that corresponds to any of 80 degrees, degrees, 90 degrees, 95 degrees, 100 degrees, 105 degrees, 110 degrees, 115 degrees, 120 degrees, 125 degrees, or 130 degrees, or any ranges thereof. Thus, the various fields of view may correspond to a range such as: 80 degrees to 85 degrees, 80 degrees to 90 degrees, 80 degrees to degrees, 80 degrees to 100 degrees, 80 degrees to 105 degrees, 80 degrees to 110 degrees, 80 degrees to 115 degrees, 80 degrees to 120 degrees, 80 degrees to 125 degrees, 80 degrees to 130 degrees, 85 degrees to 90 degrees, 85 degrees to 95 degrees, 85 degrees to 100 degrees, 85 degrees to 105 degrees, 85 degrees to 110 degrees, 85 degrees to 115 degrees, 85 degrees to 120 degrees, degrees to 125 degrees, 85 degrees to 130 degrees, 90 degrees to 95 degrees, 90 degrees to 100 degrees, 90 degrees to 105 degrees, 90 degrees to 110 degrees, 90 degrees to 115 degrees, 90 degrees to 120 degrees, 90 degrees to 125 degrees, 90 degrees to 130 degrees, 95 degrees to 100 degrees, 95 degrees to 105 degrees, 95 degrees to 110 degrees, 95 degrees to 115 degrees, 95 degrees to 120 degrees, 95 degrees to 125 degrees, 95 degrees to 130 degrees, 100 degrees to 105 degrees, 100 degrees to 110 degrees, 100 degrees to 115 degrees, 100 degrees to 120 degrees, 100 degrees to 125 degrees, 100 degrees to 130 degrees, 105 degrees to 110 degrees, 105 degrees to 115 degrees, 105 degrees to 120 degrees, 105 degrees to 125 degrees, 105 degrees to 130 degrees, 110 degrees to 115 degrees, 110 degrees to 120 degrees, 110 degrees to 125 degrees, 110 degrees to 130 degrees, 115 degrees to 120 degrees, 115 degrees to 125 degrees, 115 degrees to 130 degrees, 120 degrees to 125 degrees, 120 degrees to 130 degrees, or 125 degrees to 130 degrees.

In some examples, the horizontal overlap of the various fields of view corresponds to any of 10 degrees, 15 degrees, 20 degrees, 25 degrees, 30 degrees, 35 degrees, or any ranges thereof. Thus, the horizontal overlap of the various fields of view may correspond to a range such as: 10 degrees to 15 degrees, 10 degrees to 20 degrees, 10 degrees to 25 degrees, 10 degrees to 30 degrees, degrees to 35 degrees, 15 degrees to 20 degrees, 15 degrees to 25 degrees, 15 degrees to 30 degrees, 15 degrees to 35 degrees, 20 degrees to 25 degrees, 20 degrees to 30 degrees, 20 degrees to 35 degrees, 25 degrees to 30 degrees, 25 degrees to 35 degrees, or 30 degrees to 35 degrees.

In some examples, the vertical overlap of the various fields of view corresponds to any of 10 degrees, 15 degrees, 20 degrees, 25 degrees, 30 degrees, 35 degrees, 40 degrees or any ranges thereof. Thus, the vertical overlap of the various fields of view may correspond to a range such as: 10 degrees to 15 degrees, 10 degrees to 20 degrees, 10 degrees to 25 degrees, 10 degrees to 30 degrees, 10 degrees to 35 degrees, 10 degrees to 40 degrees, 15 degrees to 20 degrees, 15 degrees to 25 degrees, 15 degrees to 30 degrees, 15 degrees to 35 degrees, 15 degrees to 40 degrees, 20 degrees to 25 degrees, 20 degrees to 30 degrees, 20 degrees to 35 degrees, 20 degrees to 40 degrees, degrees to 30 degrees, 25 degrees to 35 degrees, 25 degrees to 40 degrees, 30 degrees to 35 degrees, 30 degrees to 40 degrees, or 35 degrees to 40 degrees.

In some examples, the upper line of sight has an angle with respect to a forward line of sight that corresponds to any of −30 degrees, −25 degrees, −20 degrees, −15 degrees, −10 degrees, −5 degrees, 0 degrees, +5 degrees, +10 degrees, +15 degrees, +20 degrees, +25 degrees, +30 degrees, +35 degrees, +40 degrees, +45 degrees or any ranges thereof. Thus, the upper line of sight may have an angle with respect to a forward line of sight that is in a range such as: −30 degrees to −25 degrees, −30 degrees to −20 degrees, −30 degrees to −15 degrees, −30 degrees to −10 degrees, −30 degrees to −5 degrees, −30 degrees to 0 degrees, −30 degrees to +5 degrees, −30 degrees to +10 degrees, −30 degrees to +15 degrees, −30 degrees to +20 degrees, −30 degrees to +25 degrees, −30 degrees to +30 degrees, −30 degrees to +35 degrees, −30 degrees to +40 degrees, −30 degrees to +45 degrees, −25 degrees to −20 degrees, −25 degrees to −15 degrees, −25 degrees to −10 degrees, −25 degrees to −5 degrees, −25 degrees to 0 degrees, −25 degrees to +5 degrees, −25 degrees to +10 degrees, −25 degrees to +15 degrees, −25 degrees to +20 degrees, −25 degrees to +25 degrees, −15 degrees to +30 degrees, −25 degrees to +35 degrees, −25 degrees to +40 degrees, −25 degrees to +45 degrees, −20 degrees to −15 degrees, −20 degrees to −10 degrees, −20 degrees to −5 degrees, −20 degrees to 0 degrees, −20 degrees to +5 degrees, −20 degrees to +10 degrees, −20 degrees to +15 degrees, −20 degrees to +20 degrees, −20 degrees to +25 degrees, −20 degrees to +30 degrees, −20 degrees to +35 degrees, −20 degrees to +40 degrees, −20 degrees to +45 degrees, −15 degrees to −10 degrees, −15 degrees to −5 degrees, −15 degrees to 0 degrees, −15 degrees to +5 degrees, −15 degrees to +10 degrees, −15 degrees to +15 degrees, −15 degrees to +20 degrees, −15 degrees to +25 degrees, −15 degrees to +30 degrees, −15 degrees to +35 degrees, −15 degrees to +40 degrees, −15 degrees to +45 degrees, −10 degrees to −5 degrees, −10 degrees to 0 degrees, −10 degrees to +5 degrees, −10 degrees to +10 degrees, −10 degrees to +15 degrees, −10 degrees to +20 degrees, −10 degrees to +25 degrees, −10 degrees to +30 degrees, −10 degrees to +35 degrees, −10 degrees to +40 degrees, −10 degrees to +45 degrees, −5 degrees to 0 degrees, −5 degrees to +5 degrees, −5 degrees to +10 degrees, −5 degrees to +15 degrees, −5 degrees to +20 degrees, −5 degrees to +25 degrees, −5 degrees to +30 degrees, −5 degrees to +35 degrees, −5 degrees to +40 degrees, −5 degrees to +45 degrees, 0 degrees to +5 degrees, 0 degrees to +10 degrees, 0 degrees to +15 degrees, 0 degrees to +20 degrees, 0 degrees to +25 degrees, 0 degrees to +30 degrees, 0 degrees to +35 degrees, 0 degrees to +40 degrees, 0 degrees to +45 degrees, +5 degrees to +10 degrees, +5 degrees to +15 degrees, +5 degrees to +20 degrees, +5 degrees to +25 degrees, +5 degrees to +30 degrees, +5 degrees to +35 degrees, +5 degrees to +40 degrees, +5 degrees to +45 degrees, +10 degrees to +15 degrees, +10 degrees to +20 degrees, +10 degrees to +25 degrees, +10 degrees to +30 degrees, +10 degrees to +35 degrees, +10 degrees to +40 degrees, +10 degrees to +45 degrees, +15 degrees to +20 degrees, +15 degrees to +25 degrees, +15 degrees to +30 degrees, +15 degrees to +35 degrees, +15 degrees to +40 degrees, +15 degrees to +45 degrees, +20 degrees to +25 degrees, +20 degrees to +30 degrees, +20 degrees to +35 degrees, +20 degrees to +40 degrees, +20 degrees to +45 degrees, +25 degrees to +30 degrees, +25 degrees to +35 degrees, +25 degrees to +40 degrees, +25 degrees to +45 degrees, +30 degrees to +35 degrees, +30 degrees to +40 degrees, +30 degrees to +45 degrees, +35 degrees to +40 degrees, +35 degrees to +45 degrees, or +40 degrees to +45 degrees.

In some examples, the lower line of sight has an angle with respect to a forward line of sight that corresponds to any of −55 degrees, −60 degrees, −65 degrees, −70 degrees, −75 degrees, −80 degrees, −85 degrees, −90 degrees, −95 degrees, −100 degrees, −105 degrees, or any ranges thereof. Thus, the lower line of sight may have an angle with respect to a forward line of sight that is in a range such as: −55 degrees to −60 degrees, −55 degrees to −65 degrees, −55 degrees to −70 degrees, −55 degrees to −75 degrees, −55 degrees to −80 degrees, −55 degrees to −85 degrees, −55 degrees to −90 degrees, −55 degrees to −95 degrees, −55 degrees to −100 degrees, −55 degrees to −105 degrees, −60 degrees to −65 degrees, −60 degrees to −70 degrees, −60 degrees to −75 degrees, −60 degrees to −80 degrees, −60 degrees to −85 degrees, −60 degrees to −90 degrees, −60 degrees to −95 degrees, −60 degrees to −100 degrees, −60 degrees to −105 degrees, −65 degrees to −70 degrees, −65 degrees to −75 degrees, −65 degrees to −80 degrees, −65 degrees to −85 degrees, −65 degrees to −90 degrees, −65 degrees to −95 degrees, −65 degrees to −100 degrees, −65 degrees to −105 degrees, −70 degrees to −75 degrees, −70 degrees to −80 degrees, −70 degrees to −85 degrees, −70 degrees to −90 degrees, −70 degrees to −95 degrees, −70 degrees to −100 degrees, −70 degrees to −105 degrees, −75 degrees to −80 degrees, −75 degrees to −85 degrees, −75 degrees to −90 degrees, −75 degrees to −95 degrees, −75 degrees to −100 degrees, −75 degrees to −105 degrees, −80 degrees to −85 degrees, −80 degrees to −90 degrees, −80 degrees to −95 degrees, −80 degrees to −100 degrees, −80 degrees to −105 degrees, −85 degrees to −90 degrees, −85 degrees to −95 degrees, −85 degrees to −100 degrees, −85 degrees to −105 degrees, −90 degrees to −95 degrees, −90 degrees to −100 degrees, −90 degrees to −105 degrees, −95 degrees to −100 degrees, −95 degrees to −105 degrees, or −100 degrees to −105 degrees.

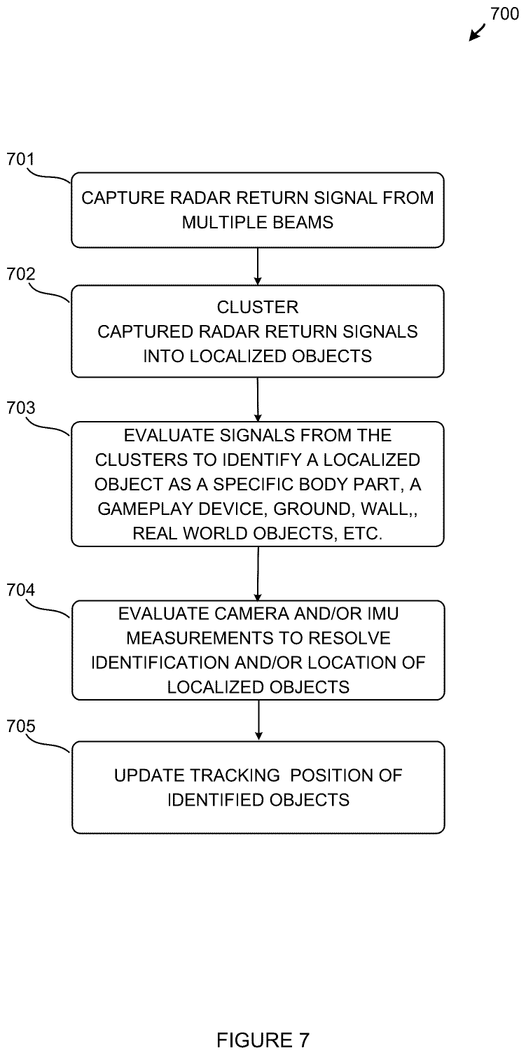

FIG. 7 is a flow chart illustrating an example process 700 for identification and tracking of objects with a head mounted display device that includes multiple sensors arranged in accordance with aspects disclosed herein. The process 770 is illustrated as a collection of blocks in a logical flow graph, which represent a sequence of operations that can be implemented in hardware, software, or a combination thereof. In the context of software, the blocks represent computer-executable instructions that, when executed by one or more processors, perform the recited operations. Generally, computer-executable instructions include routines, programs, objects, components, data structures, and the like that perform or implement particular functions. The order in which operations are described is not intended to be construed as a limitation, and any number of the described blocks can be combined in any order and/or in parallel to implement the process. Other processes described throughout this disclosure shall be interpreted accordingly.

At block 701, a radar return signal from multiple beams are captured, such as with radar sensors in a body worn device. The various radar sensors may correspond to RF transceiver systems that are each implemented as an MMIC or system on a chip, which each transmit, receive, and capture radar return signals. Each of the multiple beams may correspond to an antenna beam with a different field of view relative to a position on the body worn device (e.g., HMD or a glove). An application processor in the body worn device, which may be coupled to one or more of the radar sensor device(s), may be configured to capture the radar return signals from the radar sensors as radar sensor data or radar measurements.

At block 702, the captured radar return signals are clustered into localized objects based on measurements made in their field of view, such as by an application processor. The radar return signal may be clustered based on measurements such as distance, time of arrival, angle of arrival, Doppler shift, signal strength, signal phase, estimated direction or estimated position.

At block 703, signals are evaluated from the clusters to identify at least one localized object as one of: a specific body part, or a gameplay device, or ground, wall, or a real world object, etc. In some examples, the signals from the clusters are evaluated to identify real world objects based on radar signature characteristics associated with one or more of the real world objects. The radar signatures may be based on radar backscatter or cross-section, or other characteristics as previously described herein. The real world objects may be either a human body part or a non-human object. Identifiable human body parts may be any one of: a hand, a finger, a thumb, a palm, a wrist, a forearm, an elbow, a bicep, a shoulder, a foot, a toe, a heel, an ankle, a calf, a knee, a thigh, a hip, a waist, or a torso. Example non-human objects may correspond to any one of: a wall, a ceiling, a floor, or another object proximate to the user in the real world. In some examples, the identification of the clusters in block 703 may be performed by the application processor, or a cloud processor, or a combination of the application processor with the cloud processor.

At block 704, camera or IMU measurements may be leveraged to resolve identification and/or location determination of the localized objects. An IMU and or a camera device may be included in the body worn device. The IMU may make inertial measurements based on a position and/or orientation of the body worn device, while the camera may capture images of the real world. The measurement or IMU data and/or the camera images can be captured and/or evaluated by the application processor and then leveraged to resolve identification of the localized objects. The application processor may communicate the data to a could based processor, which may be leveraged for data storage and/or assistance in object identification, for example.

At block 705, a tracking position associated with identified objects may be updated. For example, tracking position information associated with each of the identified real world object may be stored in a database, and leveraged to update the tracking position of those objects in a 3D virtual space. The tracking position may be determined and/or update by the application processor, or by a cloud processor, or by a combination thereof.

The process of blocks 701 through 705 may be repeated in a loop, in some examples.

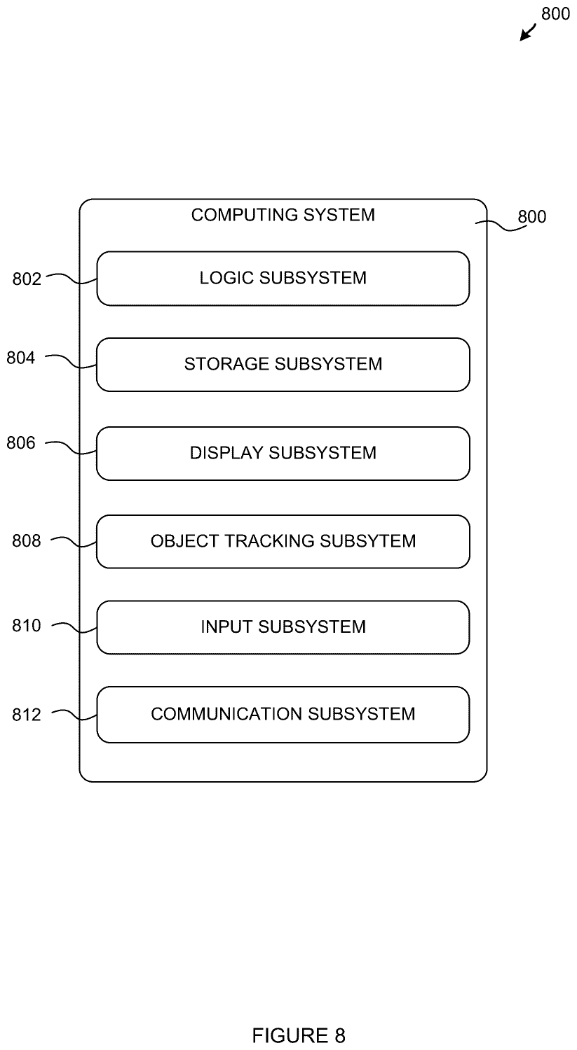

FIG. 8 is a schematic drawing of an example computing system 800 capable of implementing aspects of the techniques and technologies presented herein. Computing system 800 may take the form of one or more personal computers, network-accessible server computers, tablet computers, home-entertainment computers, gaming devices, mobile computing devices, mobile communication devices (e.g., smart phone), virtual/augmented/mixed reality computing devices, wearable computing devices, Internet of Things (IoT) devices, embedded computing devices, and/or other computing devices.

Computing system 800 may include a logic subsystem 802 and a storage subsystem 804. Computing system 800 may optionally include a display subsystem 806, an object tracking subsystem 808, an input subsystem 810, a communication subsystem 812, and/or other subsystems not shown in FIG. 8.

Logic subsystem 802 includes one or more physical devices configured to execute instructions. For example, the logic subsystem may be configured to execute instructions that are part of one or more applications, services, or other logical constructs. The logic subsystem may include one or more hardware processors configured to execute software instructions. Additionally, or alternatively, the logic subsystem may include one or more hardware or firmware devices configured to execute hardware or firmware instructions. Processors of the logic subsystem may be single-core or multi-core, and the instructions executed thereon may be configured for sequential, parallel, and/or distributed processing. Individual components of the logic subsystem optionally may be distributed among two or more separate devices, which may be remotely located and/or configured for coordinated processing. Aspects of the logic subsystem may be virtualized and executed by remotely-accessible, networked computing devices configured in a cloud-computing configuration.

Storage subsystem 804 includes one or more physical devices configured to temporarily and/or permanently hold computer information such as data and instructions executable by the logic subsystem. When the storage subsystem includes two or more devices, the devices may be collocated and/or remotely located. Storage subsystem 804 may include volatile, nonvolatile, dynamic, static, read/write, read-only, random-access, sequential-access, location-addressable, file-addressable, and/or content-addressable devices. Storage subsystem 804 may include removable and/or built-in devices. When the logic subsystem executes instructions, the state of storage subsystem 804 may be transformed—e.g., to hold different data.

Aspects of logic subsystem 802 and storage subsystem 804 may be integrated together into one or more hardware-logic components. Such hardware-logic components may include program- and application-specific integrated circuits (PASIC/ASICs), program- and application-specific standard products (PSSP/ASSPs), system-on-a-chip (SOC), and complex programmable logic devices (CPLDs), for example.

The logic subsystem and the storage subsystem may cooperate to instantiate one or more logic machines. As used herein, the term “machine” is used to collectively refer to the combination of hardware, firmware, software, instructions, and/or any other components cooperating to provide computer functionality. In other words, “machines” are never abstract ideas and always have a tangible form. A machine may be instantiated by a single computing device, or a machine may include two or more sub-components instantiated by two or more different computing devices. In some implementations a machine includes a local component (e.g., software application executed by a computer processor) cooperating with a remote component (e.g., cloud computing service provided by a network of server computers). The software and/or other instructions that give a particular machine its functionality may optionally be saved as one or more unexecuted modules on one or more suitable storage devices.

When included, display subsystem 806 may be used to present a visual representation of data held by storage subsystem 804. This visual representation may take the form of a graphical user interface (GUI). Display subsystem 806 may include one or more display devices utilizing virtually any type of technology. In some implementations, display subsystem may include one or more virtual, augmented, or mixed reality displays.

When included, object tracking subsystem 808 may be used to process any of radar sensor data, camera image data, and/or IMU data to identify objects in the real world, track their physical positions, and map their coordinates into a virtual 3D space as previously described herein.

When included, input subsystem 810 may comprise or interface with one or more input devices. An input device may include a sensor device or a user input device. Examples of user input devices include a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition.

When included, communication subsystem 812 may be configured to communicatively couple computing system 800 with one or more other computing devices. Communication subsystem 812 may include wired and/or wireless communication devices compatible with one or more different communication protocols. The communication subsystem may be configured for communication via personal-, local- and/or wide-area networks.

The disclosure presented herein also encompasses the subject matter set forth in the following clauses:

Example Clause 1: A body worn device that is worn by a user to track real world objects in a virtual space, the body worn device comprising: a first RF transceiver system at a first position of the body worn device and configured to capture radar return signals in a first field of view; a second RF transceiver system at a second position of the body worn device and configured to capture radar return signals in a second field of view; a third RF transceiver system at a third position of the body worn device and configured to capture radar return signals in a third field of view; a fourth RF transceiver system at a fourth position of the body worn device and configured to capture radar return signals in a fourth field of view; and an application processor that is configured to receive the captured radar return signals from the first, second, third and fourth RF transceiver systems. The application processor is configured to: cluster the captured radar return signals into one or more localized objects; evaluate signals from the clusters to identify localized objects as one or more of the real world objects; and update tracking position information associated with each identified real world object in the virtual space.

Example Clause 2: The body worn device of clause 1, where the first and second RF transceiver systems are positioned on opposite forward facing locations of the body worn device to configure the first and second fields of view such that the first and second fields of view are substantially forward facing relative to a forward line of sight of the user.

Example Clause 3: The body worn device of any of the above clauses, wherein the first and second RF transceiver systems are configured with substantially matched fields of view of a first matched value in a first range of about 80 degrees to about 120 degrees.

Example Clause 4: The body worn device of any of the above clauses, wherein the first and second RF transceiver systems are configured with substantially overlapped fields of view of a first overlap value in a second range of about 10 degrees to about 30 degrees.

Example Clause 5: The body worn device of any of the above clauses, where the third and fourth RF transceiver system are positioned on opposite downward facing locations of the body worn device to configure the third and fourth fields of view such that the third and fourth fields of view are substantially downward facing relative to the forward line of sight of the user.

Example Clause 6: The body worn device of any of the above clauses, wherein the third and fourth RF transceiver systems are configured to have matched third and fourth fields of view of a second matched value in a third range of about 80 degrees to about 120 degrees.

Example Clause 7: The body worn device of any of the above clauses, wherein the third and fourth RF transceiver systems are configured with substantially overlapped fields of view of a second overlap value in a fourth range of about 10 degrees to about 30 degrees.

Example Clause 8: The body worn device of any of the above clauses, wherein the first, second, third and fourth RF transceiver systems positioned about the body worn device to configure the first, second, third and fourth fields of view such that: the first and second fields of view are forward facing relative to a forward line of sight of the user and matched to a first matched value in a first field range of about 80 degrees to about 120 degrees; the third and fourth fields of view are downward facing relative to the forward line of sight of the user and matched to a second matched value in a second field range of about 80 degrees to about 120 degrees; the first and second fields are overlapped with a first overlap value in a first overlap range of about 10 degrees to about 30 degrees; the third and fourth fields are overlapped with a second overlap value in a second overlap range of about 10 degrees to about 30 degrees; the first and third fields are overlapped with a third overlap value in a third overlap range of about 10 degrees to about 30 degrees; and the second and fourth fields are overlapped with a fourth overlap value in a fourth overlap range of about 10 degrees to about 30 degrees.

Example Clause 9: The body worn device of any of the above clauses, further comprising at least one camera device that is at a fifth position of the body worn device, wherein the at least one camera device is configured to capture camera images, and wherein the application processor is further configured to evaluate measurements associated with the captured camera images to resolve identification of the localized objects as one or more of the real world objects.

Example Clause 10: The body worn device of any of the above clauses, further comprising at least one inertial measurement unit (IMU) at a fifth position of the body worn device, wherein the at least one inertial measurement unit (IMU) is configured to capture inertial measurements, and wherein the application processor is further configured to evaluate the captured inertial measurements to resolve identification of the localized objects as one or more of the real world objects.

Example Clause 11: The body worn device of any of the above clauses, wherein the application processor is further configured to resolve identification of the localized objects as one or more of the real world objects, wherein the real world objects correspond to one of: a human body part associated with the user, a gameplay object held by the user, a wall associated with a real world room, a floor associated with the real world room, or a ceiling associated with the real world room.

Example Clause 12: The body worn device of any of the above clauses, wherein the application processor is configured to communicate radar return signals to leverage a cloud based processor to cluster the radar return signals, evaluate the signals from the clusters, and/or update the tracking position information.

Example Clause 13: The body worn device of any of the above clauses, wherein the application processor is configured to cluster the radar return signals into the one or more localized objects based on one or more of distance, time of arrival, angle of arrival, Doppler shift, signal strength, signal phase, estimated direction or estimated position.

Example Clause 14: The body worn device of any of the above clauses, wherein each of the first, second, third and fourth RF transceiver systems correspond to a system on a chip implemented as a MMIC with at least one millimeter waveband transmitter, receiver, and antenna.

Example: Clause 15: The body worn device of any of the above clauses, wherein the cloud processor is configured to receive the radar return signals from the application processor, store the radar return signals in a data storage as radar sensor data, correlate the radar sensor data with backscatter patterns associated with known radar signatures, and identify one or more objects associated with the correlated backscatter patterns.

Example Clause 16: An application processor in a body worn device that is configured to track real world objects in a virtual space, wherein the application processor is configured by computer readable instructions to: capture radar sensor data from multiple beams directed in a direction relative to the user; cluster the captured radar sensor data into one or more localized objects; evaluate radar sensor data from the clusters to identify localized objects as one or more of the real world objects; and update tracking position information associated with each identified real world object in the virtual space.

Example Clause 17: The application processor of clause 17, wherein the application processor is further configured to identify the localized objects as either a human body part or a non-human object based on a backscatter pattern associated with the radar sensor data from the clusters.

Example Clause 18: The application processor of any of clauses 16 and 17, wherein the application processor is configured to identify the human body part as one of: a hand, a finger, a thumb, a palm, a wrist, a forearm, an elbow, a bicep, a shoulder, a foot, a toe, a heel, an ankle, a calf, a knee, a thigh, a hip, a waist, or a torso.

Example Clause 19: The application processor of any of clauses 16 through 18, wherein the application processor is configured to identify the non-human object as one of: a wall, a ceiling, a floor, another object proximate to the user in the real world.

Example Clause 20: The application processor of any of clauses 16 through 19, wherein the application processor is configured to cluster the captured radar sensor data by one or more of: distance, time of arrival, angle of arrival, Doppler shift, signal strength, signal phase, estimated direction or estimated position.

Example Clause 21: The application processor of any of clauses 16 through 20, wherein the application processor is configured to evaluate radar sensor data from the clusters to identify a localized object by a radar signature.

Example Clause 22. The application processor of any of clauses 16 through 21, wherein the application processor is configured to identify the radar signature by one or more of: a radar cross-section (RCS) or backscatter, a spectrum of Doppler frequencies, a modulation characteristic, or characteristic harmonics.

Example Clause 23: The application processor of any of clauses 16 through 22, wherein the application processor is configured to capture images from at least one camera device and evaluate measurements associated with the captured images to resolve identification of the localized objects as one or more of the real world objects.

Example Clause 24. The application processor of any of clauses 16 through 23, wherein the application processor is configured to capture inertial measurements from at least one inertial measurement unit (IMU) and evaluate the captured inertial measurements to resolve identification of the localized objects as one or more of the real world objects.

Example Clause 25: A method for an application processor to track real world objects in a virtual space with a body worn device, the method comprising: capturing radar return signals from multiple antenna beams, wherein each of the multiple antenna beams includes a different field of view relative to a position on the body worn device; clustering the captured radar return signals into one or more localized objects based on measurements made in their field of view; evaluating signals from the clusters to identify real world objects based on radar signature characteristics associated with one or more of the real world objects; and updating tracking position information associated with each identified real world object in the virtual space.

Example Clause 26: The method of clause 25, further comprising: communicating the captured radar return signals to a cloud based processor, and clustering the captured radar return signals with the cloud processor based on one or more of time of arrival, angle of arrival, Doppler shift, signal strength, distance or estimated position.

Example Clause 27: The method of any of clauses 25 and 26, further comprising: correlating a backscatter pattern associated with the radar signals to known radar signatures with a cloud processor to identify the localized objects as one or more of the real world objects.

Example Clause 28: The method of any of clauses 25 through 27, further comprising: identifying the real world objects as either a human body part or a non-human object based on a backscatter pattern associated with the radar sensor data from the clusters.

Example Clause 29: The method of any of clauses 25 through 28, further comprising identifying the human body part as one of: a hand, a finger, a thumb, a palm, a wrist, a forearm, an elbow, a bicep, a shoulder, a foot, a toe, a heel, an ankle, a calf, a knee, a thigh, a hip, a waist, or a torso.

Example Clause 30: The method of any of clauses 25 through 29, further comprising identifying the non-human object as one of: a wall, a ceiling, a floor, or another object proximate to the user in the real world.

Example Clause 31: The method of any of clauses 25 through 30, further comprising capturing images from at least one camera device of the body worn device, evaluating measurement associated with the captured images, and resolving identification of the localized objects as one or more of the real world objects based on the correlation between the radar signature characteristics and the measurements associated with the captured images.

Example Clause 32: The method of any of clauses 25 through 31, further comprising capturing inertial measurements from at least one inertial measurement unit of the body worn device, evaluating measurement associated with the inertial measurements, and resolving identification of the localized objects as one or more of the real world objects based on the correlation between the radar signature characteristics and the inertial measurements.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

In closing, although the various configurations have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

What is claimed is:

1. A body worn device that is worn by a user to track real world objects in a virtual space, the body worn device comprising:
a first RF transceiver system at a first position of the body worn device and configured to capture radar return signals in a first field of view;
a second RF transceiver system at a second position of the body worn device and configured to capture radar return signals in a second field of view;
a third RF transceiver system at a third position of the body worn device and configured to capture radar return signals in a third field of view;
a fourth RF transceiver system at a fourth position of the body worn device and configured to capture radar return signals in a fourth field of view; and
an application processor that is configured to receive the captured radar return signals from the first, second, third and fourth RF transceiver systems, wherein the application processor is configured to:
cluster the captured radar return signals into one or more localized objects;
evaluate signals from the clusters to identify localized objects as one or more of the real world objects; and
update tracking position information associated with each identified real world object in the virtual space.

2. The body worn device of claim 1, where the first and second RF transceiver systems are positioned on opposite forward facing locations of the body worn device to configure the first and second fields of view such that the first and second fields of view are substantially forward facing relative to a forward line of sight of the user.

3. The body worn device of claim 2, wherein the first and second RF transceiver systems are configured with substantially matched fields of view of a first matched value in a first range of about 80 degrees to about 120 degrees.

4. The body worn device of claim 3, wherein the first and second RF transceiver systems are configured with substantially overlapped fields of view of a first overlap value in a second range of about 10 degrees to about 30 degrees.

5. The body worn device of claim 2, where the third and fourth RF transceiver system are positioned on opposite downward facing locations of the body worn device to configure the third and fourth fields of view such that the third and fourth fields of view are substantially downward facing relative to the forward line of sight of the user.

6. The body worn device of claim 5, wherein the third and fourth RF transceiver systems are configured to have matched third and fourth fields of view of a second matched value in a third range of about 80 degrees to about 120 degrees.

7. The body worn device of claim 6, wherein the third and fourth RF transceiver systems are configured with substantially overlapped fields of view of a second overlap value in a fourth range of about 10 degrees to about 30 degrees.

8. The body worn device of claim 1, wherein the first, second, third and fourth RF transceiver systems positioned about the body worn device to configure the first, second, third and fourth fields of view such that:
the first and second fields of view are forward facing relative to a forward line of sight of the user and matched to a first matched value in a first field range of about 80 degrees to about 120 degrees;
the third and fourth fields of view are downward facing relative to the forward line of sight of the user and matched to a second matched value in a second field range of about 80 degrees to about 120 degrees;
the first and second fields are overlapped with a first overlap value in a first overlap range of about 10 degrees to about 30 degrees;
the third and fourth fields are overlapped with a second overlap value in a second overlap range of about 10 degrees to about 30 degrees;
the first and third fields are overlapped with a third overlap value in a third overlap range of about 10 degrees to about 30 degrees; and
the second and fourth fields are overlapped with a fourth overlap value in a fourth overlap range of about 10 degrees to about 30 degrees.

9. The body worn device of claim 1, further comprising at least one camera device that is at a fifth position of the body worn device, wherein the at least one camera device is configured to capture camera images, and wherein the application processor is further configured to evaluate measurements associated with the captured camera images to resolve identification of the localized objects as one or more of the real world objects.

10. The body worn device of claim 1, further comprising at least one inertial measurement unit (IMU) at a fifth position of the body worn device, wherein the at least one inertial measurement unit (IMU) is configured to capture inertial measurements, and wherein the application processor is further configured to evaluate the captured inertial measurements to resolve identification of the localized objects as one or more of the real world objects.

11. The body worn device of claim 1, wherein the application processor is further configured to resolve identification of the localized objects as one or more of the real world objects, wherein the real world objects correspond to one of: a human body part associated with the user, a gameplay object held by the user, a wall associated with a real world room, a floor associated with the real world room, or a ceiling associated with the real world room.

12. The body worn device of claim 1, wherein the application processor is configured to communicate radar return signals to leverage a cloud based processor to cluster the radar return signals, evaluate the signals from the clusters, and/or update the tracking position information.

13. The body worn device of claim 1, wherein the application processor is configured to cluster the radar return signals into the one or more localized objects based on one or more of distance, time of arrival, angle of arrival, Doppler shift, signal strength, signal phase, estimated direction or estimated position.

14. The body worn device of claim 1, wherein each of the first, second, third and fourth RF transceiver systems correspond to a system on a chip implemented as a MMIC with at least one millimeter waveband transmitter, receiver, and antenna.

15. An application processor in a body worn device that is configured to track real world objects in a virtual space, wherein the application processor is configured by computer readable instructions to:
capture radar sensor data from multiple beams directed in a direction relative to the user;
cluster the captured radar sensor data into one or more localized objects;
evaluate radar sensor data from the clusters to identify localized objects as one or more of the real world objects; and
update tracking position information associated with each identified real world object in the virtual space.

16. The application processor of claim 15, wherein the application processor is further configured to identify the localized objects as either a human body part or a non-human object based on a backscatter pattern associated with the radar sensor data from the clusters.

17. The application processor of claim 15, wherein the application processor is configured to cluster the captured radar sensor data by one or more of: distance, time of arrival, angle of arrival, Doppler shift, signal strength, signal phase, estimated direction or estimated position.

18. The application processor of claim 15, wherein the application processor is configured to evaluate radar sensor data from the clusters to identify a localized object by a radar signature.

19. The application processor of claim 20, wherein the application processor is configured to identify the radar signature by one or more of: a radar cross-section (RCS) or backscatter, a spectrum of Doppler frequencies, a modulation characteristic, or characteristic harmonics.

20. A method for an application processor to track real world objects in a virtual space with a body worn device, the method comprising:
capturing radar return signals from multiple antenna beams, wherein each of the multiple antenna beams includes a different field of view relative to a position on the body worn device;
clustering the captured radar return signals into one or more localized objects based on measurements made in their field of view;
evaluating signals from the clusters to identify real world objects based on radar signature characteristics associated with one or more of the real world objects; and
updating tracking position information associated with each identified real world object in the virtual space.
